(19) United States
(12) Patent Application Publication
(10) Pub. No.: US 2016/0244867 A1
(43) Pub. Date: Aug. 25, 2016

(54) PROCESS FOR INCORPORATING METAL NANOPARTICLES IN A POLYMERIC ARTICLE

(71) Applicant: Covestro LLC, Pittsburgh, PA (US)

(72) Inventors: Robert A. Pyles, Bethel Park, PA (US); Ronald C. Hedden, Lubbock, TX (US); Daniel Lentz, Woodbury, MN (US)

(21) Appl. No.: 15/147,400

(22) Filed: May 5, 2016

Related U.S. Application Data
(62) Division of application No. 12/247,501, filed on Oct. 8, 2008.
Application No. 12/247,501 is a continuation-in-part of application No. 12/156,521, filed on Jun. 2, 2008, now abandoned.

(51) Int. Cl. C23C 2/04; B05D 1/02; C08J 5/00

(52) U.S. Cl. CPC C23C 2/04; C08J 5/005; B05D 1/02

(57) ABSTRACT

A process of incorporating metal in the form of nanoparticles into the surface layer of a polymeric article and the resultant articles are disclosed. The process includes bringing at least a part of the surface of said article in contact with a solvent mixture that contains (a) water, (b) a carrier conforming to

R₁—[—O—(CH₂)ₙ]ₘOR₂

where R₁ and R₂ independently one from the other denote a radical selected from the group consisting of linear and branched C₁₋₁₈ alkyl, benzyl, benzoyl, phenyl and H, n is 2 or 3, and m is 1-35, (c) a metal precursor, and optionally (d) a leveling agent, for a time sufficient to enable infusion of at least some of said metal precursor into said article to obtain an article having a treated surface layer; and treating the surface layer with a reducing agent to produce metal in the form of nanoparticles. The inventive articles prepared by the inventive process exhibit advantageous electrical and/or optical properties.

The present application is a Divisional of U.S. Ser. No. 12/247,501, filed Oct. 8, 2008 (pending) which is a continuation-in-part of, and claims the benefit of prior application U.S. Ser. No. 12/156,521, filed Jun. 2, 2008 (now abandoned).

### FIELD OF THE INVENTION

The invention relates to processes for incorporating metal in the form of nanoparticles in a polymeric matrix.

### BACKGROUND OF THE INVENTION

Nanoparticles (in the present context these are particles having at least one dimension, preferably two dimensions of up to 100, preferably up to 50 most preferably up to 10 nanometers) have in the recent past been found useful in a variety of applications, including smart fabrics, biosensors, optics, antibacterial surfaces and electronics. Their atomic-scale dimensions make these particles useful in modifying the customary bulk properties of materials in which they are incorporated.

Blending nanoparticles with conventional materials has been reported to provide products with improved properties, including density, dimensional stability, stiffness, abrasion resistance, reduced-moisture transmission and resiliency.

U.S. Pat. No. 7,261,647 describes the use of nanoparticles to create a vapor barrier layer between a golf ball core and the cover without detrimentally affecting ball performance. The polymerization or melt blending of two monomers in the presence of nanoparticles to produce a non-ionic polymer for enhanced performance golf ball covers is described in U.S. Pat. Nos. 7,208,546 and 6,919,395.

A polymeric sheet comprising: a polymeric layer that includes poly(vinyl) butyral and a plurality of domains distributed throughout that layer is disclosed in U.S. Pat. No. 7,179,535. The domains are in the form of microcapsules that include a liquid dielectric material encapsulated in a polymeric coating. An agent dispersed in the dielectric material causes an alteration in the amount of visible light that can be transmitted through the polymer sheet in response to the application of an electric field.

U.S. Pat. No. 7,166,412 discloses the preparation of photosensitive metal nanoparticles and a method of forming a conductive film on a substrate. U.S. Pat. No. 6,881,490 disclosed inorganic particle/polymer composites that involve chemical bonding between the elements of the composite. Included are composites where polymer having side groups chemically bonds to inorganic particles. The composite composition may include chemically bonded inorganic particles and ordered copolymers.

S. D. Evans et al., J. Mater. Chem., 2000, 10, 183, 188 produce a cast thin film of thiophenol-derivatived gold particles on a substrate surface by dissolving the gold particles and polymer in a solvent, pouring the solution onto the substrate surface and evaporating the solvent. WO 96/07487 disclosed a method of producing a thin film structure from particles of nanometer dimensions. The method entails forming at least one layer of metal or semi-conductor particles onto a substrate by treating the substrate with a polyfunctional linker molecule so that a first reactive group of the polyfunctional linker molecule reacts with the substrate linking it thereto and subsequently treating the functionalized substrate with a solution of the metal or semi conductor particles so that a second reactive group of the polyfunctional linker molecules reacts with the metal or semi-conductor particles linking it thereto.

WO99/27357 discloses a process for treating a substrate with mercaptoalkylsilane. The treated substrate is subsequently immersed in a solution containing gold nanoparticles derivatized with alkylthiols on the nanoparticle surfaces thereby forming a reactive species which attach the nanoparticles to the substrate surface. The processes used to incorporate the nanoparticles thus disclosed entail a thorough mixing of nanoparticles with the plasticated material, chemically modifying the substrate surface to bond with nanoparticles that are subsequently exposed to the reactive surfaces, or alternatively, mixing the nanoparticles into uncured resins, applying the resins to the surface of substrate materials with subsequent curing.

U.S. Pat. No. 6,603,038 disclosed a method for producing a catalyst containing one or several metals from the group of metals comprising the sub-groups Ib and VIIIb of the periodic table on porous support particles. The first step of the process a compound a relevant metal is applied to a porous support, and in a second step the support is treated with a reduction agent, to obtain metal nanoparticles produced in situ in the pores of the support.

Infusion of coloring agents and functional additives into polymeric matrices and to articles comprising such matrices has been disclosed in U.S. Pat. Nos. 6,749,646; 6,929,666; 7,094,263; 6,733,543: 6,949,127; 6,994,735; and 7,175,675.

### SUMMARY OF THE INVENTION

The present invention provides a process of incorporating metal in the form of nanoparticles into the surface layer of a polymeric article and articles made from that process. The inventive process includes bringing at least a part of the surface of said article into contact with a solvent mixture that contains

(a) water,

(b) a carrier conforming to

R₁—[—O—(CH₂)ₙ]ₘOR₂

where R₁ and R₂ independently one from the other denote a radical selected from the group consisting of linear and branched C₁₋₁₈ alkyl, benzyl, benzoyl, phenyl and H, n is 2 or 3, and m is 1-35,

(c) a metal precursor, and optionally

(d) a leveling agent,

for a time and at temperature sufficient to infuse of at least some of said metal precursor into said article to obtain an article having a treated surface layer; and then treating the surface layer with an agent to reduce the metal precursor to yield metal in the form of nanoparticles. The relative amounts of the components of the solvent mixture and the amount of reducing agent are the ones sufficient to impart to an article prepared by the inventive process advantageous electrical and/or optical properties, the advantages in comparison to a corresponding article that has not thus been prepared.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

The present invention provides a process of incorporating metal in the form of nanoparticles in a polymeric article involving (a) applying to at least a portion of the surface of said article a solvent mixture containing (i) a metal precursor (ii) water, (iii) at least one carrier conforming structurally to R₁—[—O—(CH₂)ₙ]ₘOR₂ where R₁ and R₂ independently one from the other denote a radical selected from the group consisting of linear and branched C₁₋₁₈ alkyl, benzyl, benzoyl, phenyl and H, n is 2 or 3, and m is 1-35 and optionally (iv) a diol selected from the group consisting of linear and branched C₂₋₂₀-aliphatic diols, poly(C₂₋₄-alkylene glycol), C₅₋₈-cycloaliphatic diols, monocyclic aromatic diols and aromatic dihydroxy compounds to obtain a treated article, the applying being for a time and at temperature sufficient to infuse of at least some of said metal precursor into said article to obtain an article having a treated surface layer and (b) treating at least a portion of said treated surface layer with a reducing agent solution under conditions calculated to reduce the metal precursor to yield metal in the form of nanoparticles.

The present invention further provides a polymeric article including a polymeric material, said polymeric article containing infused metal nanoparticles, wherein said nanoparticles include the reduction product of infused metal precursors with a reducing agent solution.

The term “article” as used herein refers to an article of manufacture, or a semi-finished article in the form pellets, sheet or rod, that comprise polymeric resin or a resinous composition. The term “surface layer” as used in the context of the invention refers to a layer at a depth of up to 50 microns, more preferably up to 30 microns and most preferably up to 25 microns from the surface.

The inventive polymeric article prepared by the process of the present invention exhibit advantageous electrical and/or optical properties, the advantage being relative to the corresponding property of the pre-process article.

The polymeric materials suitable in the present invention may be thermoplastic or thermosetting polymers or compositions containing such polymers. Among the suitable materials are material systems that contain at least one of (co)polyesters, aliphatic polycarbonate, polyester polycarbonate copolymers, styrenic copolymers such as SAN and acrylonitrile-butadiene-styrene (ABS), acrylic polymers such as polymethyl-methacrylate and butylacrylate/SAN resins (ASA) polyamide, and polyurethane and blends of one or more of these resins. Particularly, the invention is applicable to thermoplastic polyurethanes and polymethylmethacrylate.

The solvent mixture contains a metal precursor, water, a carrier and an optional leveling agent. The water content of the solvent mixture is a positive amount up to 80 percent relative to its weight (pbw), preferably 60 to 75 pbw, more preferably 60 to 70 pbw. The carrier is present in the mixture at a positive amount of up to 30 pbw, preferably 15 to 25 pbw, the content of the optional leveling agent is up to 15 pbw preferably 5 to 15 pbw. According to the present invention, the article is treated by applying the solvent mixture to at least a portion of its surface for a time and at temperature sufficient to facilitate at least some infusion of the metal precursor into the article to obtain a treated surface layer. For treating articles made of thermoplastic polyurethane or acrylic, the temperature of the solvent mixture is about 55 to 95° C., most preferably in the range of 55 to 70° C. and the application time is typically less than 1 hour, most preferably in the range of 1 to 20 minutes. For creating a gradient of metal nanoparticles, the article is immersed in the solvent mixture and is gradually withdrawn therefrom at a predetermined rate, to affect a gradient of infused precursor, the portion of the article that remains in the solvent mixture the longest is impregnated, that is infused with the most metal precursor

The metal precursor to be used in accordance with the invention may be organic or inorganic and must be at least moderately water soluble or made moderately water soluble through chemical modification. Suitable precursors include water soluble metal compounds selected from the group consisting of oxides, hydroxyls, nitrides, nitrates, carbides, carbonates, bicarbonates, sulfides, sulfites, sulfates, iodates, chromates, dichromates, chlorites, chlorates, bromates, perchlorates, perbormates, periodates, phosphites, phosphates, arsenites, arsenates, acetates, halides, and complex anions (complex anions are those which have a molecular structure consisting of a central atom bonded to other atoms by coordinate covalent bonds, a.k.a. chelate compounds, coordination compounds and Werner complexes.) Precursors in the form of metal salts are by far the most preferred metal compounds to be used as precursors. The preferred metals are gold and silver.

Among the suitable gold compounds are those represented by AuX where X denotes chlorine, bromine or iodine, and AuX₃ where X denotes bromine, chlorine or iodine, and AuX₄⁻Y⁺, where X denotes bromine, chlorine or iodine, and Y denotes Na⁺, K⁺ or H⁺ particularly suitable are AuBr₃, AuBr₄⁻K⁺, AuBr₄⁻Na⁺, AuBr₄⁻H⁺, AuCl, AuCl₃, AuCl₄⁻K⁺, AuCl₄⁻N⁺, AuCl₄⁻H⁺, AuI and AuI₃.

Among the suitable silver compounds are those represented by AgX where X denotes fluorine, chlorine, bromine or iodine, BF₄⁻, BrO₃⁻, ClO₃⁻, ClO₄⁻, PF₆, SBF₆⁻, IO₃⁻, MnO₄⁻, VO₃⁻, ReO₄⁻, or by AgX₂ where X denotes fluorine, or by Ag₂X where X denotes O⁻², CrO₄⁻², SO₃⁻², SO₄⁻², or by Ag₃X where X denotes AsO₄⁻³ or PO₄⁻³ or by Ag₈X where X denotes W₄O₁₆⁻⁸.

Particularly suitable silver compounds are AgBF₄, AgBr, AgBrO₃, AgCl, AgClO₃, AgClO₄, AgF, AgF₂, AgPF₆, AgSbF₆, AgIO₃, AgMnO₄, AgNO₂, AgNO₃, Ag₂O, AgVO₃, AgReO₄, Ag₂CrO₄, Ag₂SO₃, Ag₂SO₄, Ag₃AsO₄, Ag₃PO₄, and Ag₈W₄O₁₆.

The concentration of precursor in the solvent mixture is not critical to the process and may be determined by routine experimentation. Accelerated infusion may be attained by higher concentration, and/or temperature and/or time of contact of the solvent mixture with the surface of the article to be treated. A typical concentration of precursor in the bath is 0.4 pbw, but there is considerable latitude in this regard. Generally, precursor may be present in the solvent mixture at a level of about 0.1 to 20 pbw preferably 0.3 to 0.5 pbw.

The carrier suitable in the context of the invention conforms structurally to

R₁—[—O—(CH₂)ₙ]ₘOR₂

where R₁ and R₂ independently one from the other denote a radical selected from the group consisting of linear and branched C₁₋₁₈ alkyl, benzyl, benzoyl, phenyl and H, n is 2 or 3, and m is 1-35, preferably 1-12, most preferably 1. Aromatic versions of R₁ and R₂ may, independently one from the other, be substituted in the aromatic ring by alkyl and or halogen. Most preferably R₁ denotes butyl and R₂ denotes H.

The optional leveling agent (in an amount of 0 to 15 pbw, preferably 5 to 15 pbw, most preferably 10 to 15 pbw) is an ionic and/or non ionic substance that promotes even distribution of the precursor over the surface of the article. Suitable anionic leveling agents include amine salts or alkali salts of carboxylic, sulfamic or phosphoric acids, for example sodium lauryl sulfate, ammonium lauryl sulfate, lignosulfonic acid salts, ethylene diamine tetra acetic acid (EDTA) sodium salts and acid salts of amines such as laurylamine hydrochloride or poly(oxy-1,2-ethanediyl), alpha-sulfo-omega-hydroxy ether with phenol 1-(methylphenyl)ethyl derivative ammonium salts; or amphoteric, that is, compounds bearing both anionic and cationic groups, for example lauryl sulfobetaine; dihydroxy ethylalkyl betaine; amido betaine based on coconut acids; disodium N-lauryl amino propionate; or the sodium salts of dicarboxylic acid coconut derivatives. Suitable non-ionic leveling agents include ethoxylated or propoxylated alkyl or aryl phenolic compounds such as octylphenoxypolyethyleneoxyethanol or poly(oxy-1,2-ethanediyl), alpha-phenyl-omega-hydroxy, styrenated, polyols and diols. Suitable diols include the optionally halogen-substituted, linear or branched C₂₋₂₀ aliphatic diols, poly(C₂₋₄ alkylene glycol), C₅₋₈-cycloaliphatic diols, monocyclic aromatic diols and aromatic dihydroxy compounds. The preferred leveling agent is diethylene glycol (DEG).

Leveling agents, such as disclosed in “Lens Prep II”, a commercial product of Brain Power International (BPI) and LEVEGAL DLP a product of Bayer MaterialScience LLC, now Covestro LLC, (a pre-formulated mixture) are also useful for practicing the present invention.

According to an embodiment of the invention, an article, preferably molded of acrylic or polyurethane compositions, is immersed in the solvent mixture. The solvent mixture at a temperature that is less than the boiling temperature of water and preferably 50 to 95° C. is applied to the article to be treated. The suitable temperature depends on the composition of the article to be treated and may be determined by routine testing. Experience shows that for articles molded of polyurethane the better results are obtained where the temperature of the solvent mixture was 60 to 70° C. In accordance with this embodiment of the invention, the immersed article is withdrawn after only a few minutes to provide a treated article. The length of time in which the article remains immersed in the bath and the process conditions depends upon the desired degree of infusion of precursor into the surface layer. Naturally, higher concentrations of precursor and higher temperatures will increase the rate of infusion. However, care must be taken not to adversely affect the surface properties of transparent articles used in optical applications or to exceed the heat distortion temperature and thus thermally deform the article.

The application of the solvent mixture to the surface of the article may be by immersing, spraying or by flow coating to obtain an article containing the precursor in the surface layer (treated article).

“Spraying” in the present context refers to applying the solvent solution to the article in the form of droplets, fog or mist. The term flow coating as used in the present context means applying the solvent solution to the article in the form of a continuous liquid film.

The treated article that contains the infused precursor may then be washed and in a further step is infused with a reducing agent, preferably from solution, to yield, in situ, metal nanoparticles in the surface layer via redox reaction. Suitable reducing agents are those substances that are capable of donating electrons to the precursors, and in the process, reduce the precursors to the corresponding metal, preferably gold and silver. Examples of such reducing agents include citrates such as potassium citrate, sodium citrate, amino and ammonium compounds, hydrazine, hydroxylamine, sodium hypophosphite, alkali metal borohydrides such as sodium borohydride, potassium borohydride; gaseous reducing agents such as hydrogen, carbon monoxide; formaldehyde, formates, acetates, oxalates, suitable sulfanilates such as sodium hydroxymethanesulfinate; and monohydric or dihydric alcohols such as ethanol, ethylene glycol.

Among these, preference is given to (alkali metal/alkaline earth metal/ammonium) citrates, formates, acetates, alkali metal borohydrides, oxalates, amines, and suitable sulfanilates.

An advantageous embodiment of the invention uses triethylamine (“TEA”), ammonium citrate, potassium citrate and/or sodium citrate as reducing agent.

The reducing agent is generally used in a stoichiometric amount based on the metal compound(s), but is preferably used in a small excess. The excess can be, for example, from 1.1 to 2, preferably from 1.1 to 1.5, mole equivalents.

The in-situ reduction is preferably carried out at temperatures of up to 95° C.

Advantageously the reducing agent conforms to

NR₁,R₂, and R₃, (i)

where R₁, R₂ and R₃ are independently one of the others selected from alkyl, benzyl, benzoyl, phenyl and H;
or

N⁺R₁,R₂,R₃,R₄X⁻ (ii)

where R₁, R₂, R₃ and R₄ are independently selected from alkyl, benzyl, benzoyl, phenyl and H and X⁻ is a nitrate, sulfate, hydroxyl, halide or other suitable anions.

Experience has shown that the presence of particulate matter in the solvent mixture is highly undesirable. Such particulates, for instance, un-dissolved precursor tend to adhere to the surface of the article and/or clog the equipment used in applying the solvent solution. Consequently, successful practice of the inventive process entails solvent solution that is virtually free of, preferably includes no, particulate matter.

In an embodiment of the inventive process, the solvent mixture is contained in one compartment and the article to be treated is positioned in another compartment of the same vessel or in a different vessel. The solvent mixture is may be filtered to remove any insoluble precursor and then pumped through suitable dispensers, such as atomizing nozzles or manifolds positioned in the vessel that contain the article and applied to the article in a manner calculated to expose a predetermined area of the article to the solvent mixture.

In a variation of the above, the first compartment of said vessel is sized to contain a large article (e.g. sheet) and is equipped with a plurality of nozzles or dispensers that are positioned so as to enable contact between the solvent mixture and the article at a sufficient temperature and for a time calculated to infuse the precursor to the article. These dispensers may be a series of atomizing nozzles that create a fine mist that covers the surface of the article to be treated, or alternatively, a manifold that will direct the flow of the solvent mixture over the surface of the article. An advantage of this embodiment of the inventive process over immersion in a solvent mixture is the great reduction, often by a factor of 10, of the quantity of solvent needed to treat large articles.

The limited quantity of solvent mixture makes it possible to also reduce the size of the ancillary equipment, such as pumps and heaters. In addition, the use of nozzles, or alternatively a manifold, directs the heated solvent mixture directly onto the surface of the article. Hence, the ability to supply fresh solvent that contains precursor to the surface of the article does not require strong agitation of the solvent mixture which is necessary to achieve uniformity of the treatment in the embodiment where immersion is the mode of applying the solvent mixture. Note, that in the practice of this embodiment of the inventive process, the article to be treated is at no time immersed in the heated solvent mixture. Excess solvent mixture that may drip from the article is collected at the bottom of the first compartment containing the article being treated and is transferred back to the second compartment where the solvent mixture is brought back to the starting temperature, re-saturated with precursor and recycled. The recycling process is continued until the article is infused with the desired level of precursor.

The inventive process may also be designed so that after the article has been treated, the equipment (e.g., atomizing nozzles) is used to deliver first a high pressure, precursor-free solvent solution and then water spray to remove excess precursor and solvent mixture, respectively, from the treated article. In addition, hot air blowers or a water vacuum may be installed in the compartment containing the treated article for purpose of drying.

In the practice of the inventive process, it is sometimes desired to change the compositional makeup of the bath, such as for making it useable for different precursors. In these instances, it was found to be more economical and environmentally desirable to re-use the solvent. The purification of the inventive solvent mixture to obtain a clean, precursor-free system was found to be readily attainable by passing it through activated carbon. The activated carbon may be used as a column or a bed or any other configuration that will allow the passage of the solvent mixture that contains the precursor resulting in a precursor-free solvent mixture. While activated carbon has long been used for separating out the organic components from a solution, it was surprising that a solvent mixture that contains more than one component could be thus purified. Experiments have shown the surprising efficacy of activated carbon in purifying the organic solution of the inventive process thus enabling re-use of the solvent.

The color of the inventive articles may be manipulated by controlling the size distribution of the nanoparticles and their aggregates. By changing process parameters it is possible to create purple & blue (50-100 nm), red/pink (<50 nm), or gray (>100 nm) colors by controlling the size and size distribution of gold nanoparticles contained in articles subjected to the inventive process.

The polymeric material may include one or more additives that are known in the art for their function in the context of these materials. Such additives include mold release agents, fillers, reinforcing agents (in the form of fibers or flakes, most notably, metal flakes, such as, aluminum flakes and/or glass) flame retardant agents, light-diffusing agents pigments and opacifying agents, such as, titanium dioxide and the like, drip suppressants such as polytetrafluoroethylene, impact modifiers, UV-stabilizers, hydrolytic stabilizers and thermal stabilizers.

Inventive articles may be molded by any methods including compression molding, injection molding, rotational molding, extrusion, injection and extrusion blow molding, and casting, the method of molding is not critical to the practice of the inventive process. The articles of the present invention may be any of large variety of items including such as are useful in the optical, electronics and medical sectors.

The inventive molded articles may be any of a variety of useful items and include computer keyboards, cellular phones, packaging and containers of all types, including ones for industrial components, residential and commercial lighting fixtures and components sheets used in building and construction, small appliances and their components, optical and sun-wear lenses, biosensors, explosive detectors as well as functional films including such films that are intended for use in film insert molding and electronics.

The present invention may be more fully understood with reference to the examples set forth below. The examples are in no way to be considered as limiting, but instead are provided as illustrative of the invention.

### Experimental

Specimens of thermoplastic polyurethane (TEXIN 245, TEXIN 250, TEXIN 255, TEXIN 285, TEXIN DP 7-1703 and TEXIN DP-7-1199 elastomers, all products of Bayer MaterialScience LLC, now Covestro LLC) were injection molded to produce flat slabs of approximate dimensions (7.5 cm×15 cm). The thicknesses of the specimens were about 3.0 mm. Acrylic specimens were cut from a sheet of 2.3 mm thickness. Polycarbonate specimens (5 cm×7.5 cm×2.6 mm thickness) were injection molded of MAKROLON 2608 polycarbonate (a product of Bayer MaterialScience LLC, now Covestro LLC).

The articles were infused with precursor (HAuCl₄) by exposure to a dilute solution (7.00·10⁻³ M) of HAuCl₄ in a solvent mixture (70% distilled water, 20% butyl cellosolve, 10% diethylene glycol, by volume) at 60° C. The treated articles were then thoroughly washed with HAuCl₄-free water/butylcellosolve/diethylene glycol solution followed by distilled water rinse. The article was in a second processing step infused with triethylamine to reduce the precursor to form gold metal in the form of nanoparticles. Reductions were performed at either 23° C. (acrylic) or 60° C. (for the thermoplastic polyurethane) by immersing the treated articles in a stirred solution of 0.072 M TEA in distilled water. Samples were allowed to air dry at 80° C. for 3 days prior to further characterization during which time the growth of the gold nanoparticles proceeded to completion and the color of the article stabilized.

Gold nanoparticles were determined (by optical microscopy) in the polyurethane articles at a depth of 25 to 30 micrometers. The corresponding depth in the acrylic specimens was determined as 15 micrometers. UV-Vis spectra of TEA-reduced samples confirmed the presence of gold nanoparticles (about 20 nm in size) in both the polyurethane and acrylic samples.

The polycarbonate articles (MAKROLON 2608, a product of Bayer MaterialScience LLC, now Covestro LLC) were subjected to the inventive process, by immersion for up to 20 minutes in a solvent mixture as described above at about 95° C. The article that remained optically clear was determined to incorporate under these conditions no significant amount of the gold precursor.

In a second set of experiments, thermoplastic polyurethane articles (TEXIN 245, TEXIN 250, TEXIN 255, TEXIN 285, TEXIN DP 7-1703 and TEXIN DP-7-1199, products of Bayer MaterialScience LLC, now Covestro LLC) were infused with the silver precursor, silver nitrate (AgNO₃), by exposure to a dilute solution of (7.00·10⁻¹ M) silver nitrate in a solvent mixture (70% distilled water, 20% butyl cellosolve, 10% diethylene glycol, by volume) at 60° C. The treated articles were then thoroughly washed with a distilled water rinse, and subsequently allowed to air dry at 80° C. for three days. Polycarbonate articles (MAKROLON 2608, a product of Bayer MaterialScience LLC, now Covestro LLC) were subjected to the inventive process, by immersion for up to 20 minutes in a solvent mixture described above at about 95° C., and then similarly, rinsed thoroughly with distilled water and air dried at 80° C. for three days.

These thermoplastic polyurethane and polycarbonate treated articles were subsequently characterized for the presence and size of silver particles after the in situ reduction of the silver nitrate to silver metal. The silver nitrate-infused articles were treated in another processing step to reduce the silver nitrate in situ to metallic silver by immersing the samples in dilute aqueous sodium borohydride (NaBH₄). Reductions were performed at 23° C. by immersing the treated articles in a stirred solution of NaBH₄ (10⁻² M) in distilled water. The articles were allowed to air dry at 80° C. for three days prior to further characterization, during which time the growth of the metallic silver nanoparticles proceeded to completion and the light to medium brown color of the article stabilized. The presence of infused silver particles was inferred from the darker color of the silver-treated articles compared to control articles that had not been exposed to the silver nitrate, which instead exhibited a pale yellow color or no color change after reduction with NaBH₄. Under solution conditions, the silver nitrate was reduced to silver metal in the form of nanoparticles and/or micrometer-sized particles.

TEM characterization of NaBH₄-reduced articles confirmed the presence of silver particles (20-50 nm or greater in size) in the polyurethane samples. Optical microscopy revealed that samples exposed to high concentrations of silver nitrate (7.00·10⁻¹ M) contained some embedded silver particles as large as 10 micrometers in diameter.

The polycarbonate article remained optically clear and was determined to incorporate under these conditions no significant amount of silver compounds.

The silver nitrate containing articles were further evaluated for antibacterial properties. As can be appreciated by reference to Table I, control samples (untreated TEXIN thermoplastic polyurethane and MAKROLON polycarbonate (labeled UNTREATED), a second set of control samples (treated with only the infusion solvents but no silver nitrate (labeled SOLVENT ONLY), and the samples treated with the silver nitrate solution as described above (labeled TREATED), were analyzed in the standard assay using a dilute buffer according to ASTM E-2149. The silver nitrate treated samples killed 99.9% of the bacterial cells, P. aeruginosa. The control samples treated with the solvent but no silver nitrate, and the untreated samples were ineffective in killing the bacterial cells, indicating that the silver nitrate was the source of the antibacterial activity. Because the MAKROLON polycarbonate samples were found to contain no significant amount of silver nitrate compounds, there was no significant bacterial antibacterial activity, as shown.

TABLE I

| | SURVIVING |
|---|---|
| | CELLS |
| SAMPLE | (AVERAGE) |
| TEXIN DP 7-1703 | |
| Treated | 2.00 × 10³ |
| Solvent Only | 1.80 × 10⁶ |
| Untreated | 2.17 × 10⁶ |
| TEXIN 245 | |
| Treated | 3.20 × 10² |
| Solvent Only | 5.80 × 10⁶ |
| Untreated | 7.33 × 10⁶ |
| MAKROLON | |
| POLYCARBONATE | |
| Treated | 4.00 × 10⁶ |
| Solvent Only | 6.50 × 10⁶ |
| Untreated | 6.47 × 10⁶ |
| Blank | 2.90 × 10⁶ |
| Titer | 5.00 × 10⁶ |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process of incorporating metal in the form of nanoparticles in a polymeric article comprising:
(a) applying to at least a portion of the surface of the polymeric article a solvent mixture containing
(i) a metal precursor,
(ii) water,
(iii) at least one carrier conforming structurally to
R₁—[—O—(CH₂)ₙ]ₘOR₂
where R₁ and R₂ independently one from the other denote a radical selected from the group consisting of linear and branched C₁₋₁₈ alkyl, benzyl, benzoyl, phenyl and H, n is 2 or 3, and m is 1-35,
for a time and at temperature sufficient to infuse at least some of the metal precursor into the article to obtain an article having a treated surface layer; and
(b) treating at least a portion of the treated surface layer with a reducing agent solution under conditions calculated to reduce the metal precursor to yield metal in the form of nanoparticles.

2. The process of claim 1, wherein said polymeric article contains at least one member selected from the group consisting of polyurethane, polymethylmethacrylate, polyester, polyamide, polystyrene, polyetherimide, and acrylonitrile-butadiene-styrene (“ABS”).

3. The process of claim 1, where the reducing agent is a substance capable of donating electrons to said precursor, and reduce it to the corresponding metal.

4. The process of claim 3 wherein the substance is at least one member selected from the group consisting of citrate, ammonium compound, hydrazine, amine, hypophosphite, borohydride, hydrogen, carbon monoxide, formaldehyde, formate, acetate, oxalate, sulfanilate and alcohol.

5. The process of claim 4 wherein said substance is at least one member selected from the group consisting of triethylamine (“TEA”), ammonium citrate, potassium citrate and sodium citrate.

6. The process of claim 1 wherein the reducing agent conforms to
NR₁,R₂, and R₃, (i)
where R₁, R₂ and R₃ are independently one of the others selected from alkyl, benzyl, benzoyl, phenyl and H;
or to
N⁺R₁,R₂,R₃,R₄X⁻ (ii)
where R₁, R₂, R₃ and R₄ are independently selected from alkyl, benzyl, benzoyl, phenyl and H and X⁻ is a nitrate, sulfate, hydroxyl, halide or other suitable anions.

7. The process of claim 1 wherein said precursor is at least one moderately water soluble metal compound selected from the group consisting of oxides, hydroxyls, nitrides, nitrates, carbides, carbonates, bicarbonates, sulfides, sulfites, sulfates, iodates, chromates, dichromates, chlorites, chlorates, bromates, perchlorates, perbormates, periodates, phosphites, phosphates, arsenites, arsenates, acetates, halides, and complex anions.

8. The process of claim 7 wherein the precursor is at least one metal salt.

9. The process of claim 1 wherein the metal is at least one member selected from the group consisting of silver and gold.

10. The process of claim 1 wherein the metal precursor is a member selected from the group consisting of AuX, AuX₃ where X denotes bromine, chlorine or iodine, and AuX₄⁻Y⁺, where X denotes bromine, chlorine or iodine, and Y⁺ denotes Na⁺, K⁺ or H⁺.

11. The process of claim 10 wherein the metal precursor is a member selected from the group consisting of AuBr₃, AuBr₄⁻K⁺, AuBr₄⁻Na⁺, AuBr₄⁻H⁺, AuCl, AuCl₃, AuCl₄⁻K⁺, AuCl₄⁻Na⁺, AuCl₄⁻H⁺, AuI and AuI₃.

12. The process of claim 1 wherein the metal precursor is a member selected from the group consisting of
AgX
where X denotes fluorine, chlorine, bromine, iodine, BF₄⁻, BrO₃⁻, ClO₃⁻, ClO₄⁻, PF₆, SBF₆⁻, IO₃⁻, MnO₄⁻, VO₃⁻, or ReO₄⁻,
AgX₂
where X denotes fluorine,
Ag₂X
where X denotes O⁻², CrO₄⁻², SO₃⁻², or SO₄⁻²,
Ag₃X
where X denotes AsO₄⁻³ or PO₄⁻³ and
Ag₈X
where X denotes W₄O₁₆⁻⁸.

13. The process of claim 1 wherein the metal precursor is a member selected from the group consisting of AgBF₄, AgBr, AgBrO₃, AgCl, AgClO₃, AgClO₄, AgF, AgF₂, AgPF₆, AgSbF₆, AgIO₃, AgMnO₄, AgNO₂, AgNO₃, Ag₂O, AgVO₃, AgReO₄, Ag₂CrO₄, Ag₂SO₃, Ag₂SO₄, Ag₃AsO₄, Ag₃PO₄, and Ag₈W₄O₁₆.

14. The process of claim 1 wherein applying is by immersion, spraying or flow coating.

15. The process of claim 1 wherein the reducing agent solution comprises triethylamine (“TEA”).

16. The process of claim 1 wherein the solvent mixture further comprises:
(iv) a diol selected from the group consisting of linear and branched C₂₋₂₀-aliphatic diols, poly(C₂₋₄-alkylene glycol), C₅₋₈-cycloaliphatic diols, monocyclic aromatic diols and aromatic dihydroxy compounds.
